(19) United States
(12) Patent Application Publication
(10) Pub. No.: US 2010/0119294 A1
(43) Pub. Date: May 13, 2010

(54) FASTENING SYSTEM FOR FASTENING AN OBJECT IN A VEHICLE

(75) Inventors: Hasso WEINMANN, Lubeck (DE); Wolfgang RITTNER, Siblin (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: DRAGER AEROSPACE GMBH, Lubeck (DE)

(21) Appl. No.: 12/608,189

(22) Filed: Oct. 29, 2009

Related U.S. Application Data
(62) Division of application No. 11/749,372, filed on May 16, 2007, now abandoned.

(30) Foreign Application Priority Data
May 16, 2006 (DE) 102006022679.8

(51) Int. Cl. F16B 1/00

(52) U.S. Cl. 403/5

(57) ABSTRACT

A fastening system is provided for fastening an object in a vehicle, in particular in an aircraft. The system includes at least one fastening element arranged between the object to be fastened and the vehicle. The fastening element has at least one cavity, which may be changed in shape by fluid impingement, such that the fastening element fixes the object in the vehicle by shape change.

### CROSS-REFERENCE TO RELATED APPLICATIONS

The present application is a division of pending U.S. patent application Ser. No. 11/749,372, filed May 16, 2007 and entitled “Fastening System for Fastening an Object in a Vehicle.”

### BACKGROUND OF THE INVENTION

The invention relates to a fastening system for fastening an object in a vehicle, in particular in an aircraft, with at least one fastening element arranged between the object to be fastened and the vehicle.

In the construction of an aircraft, a multitude of consoles, personal service units, oxygen boxes, and other items must be assembled in the cabin area. Until now, it has been usual to fix these installation elements in the cabin with conventional mechanical fastening elements, for example screws. Due to the multitude of installation elements, which need to be installed into the passenger space of a passenger aircraft, for example, the fastening of these installation elements takes up much time. This is in stark contrast to the efforts of the aircraft manufacturer to reduce the assembly costs for passenger aircraft due to the great price competition of the market.

### BRIEF SUMMARY OF THE INVENTION

Against this background it is an object of the present invention to create a fastening system with which consoles, personal service units and the like, can be securely fastened in aircraft cabins, and which permits an inexpensive assembly.

This object is achieved by a fastening system according to the invention, for fastening an object in a vehicle, in particular in an aircraft. The system comprises at least one fastening element arranged between the object to be fastened and the vehicle, wherein the fastening element comprises at least one cavity which may be changed in shape by fluid impingement, and which fixes the object in the vehicle by a shape change.

The basic concept of the present invention is to fix the object to be fastened by shape change of one or more fastening elements in the vehicle, i.e., in the structure of the vehicle, wherein the shape change is not effected by a mechanical deformation of the fastening element, as is known with riveting for example, but rather by fluid impingement, thus by pressure impinging with a fluid. Such a fastening system has the significant advantage that with a suitable design, objects may be fastened simply and quickly with a few hand manipulations, even over longer lengths, by impinging the fastening element with fluid when the objects are in their assigned position.

The fastening element is advantageously designed such that the object may be brought into the assembly position in a simple manner when the cavity of the fastening element is not impinged by fluid. Apart from this, the design of the fastening element permits the fluid impingement of its cavity to lead to a volume expansion, and/or change in its cross-sectional contour. On account of this shape change of the cavity, the fastening element creates a preferably positive and non-positive fit connection between the object to be fastened and the vehicle, which fixes the object in the vehicle, without additional known mechanical fastening means being required. A further advantage of the fastening system according to the invention is its capability of bringing the object to be fastened automatically into its assigned position by fluid impingement of a cavity of the fastening element in the position of installation. Furthermore, the fastening element advantageously forms a damping element between the vehicle and the object fastened thereon. With regard to the fluid with which the cavity is filled with pressure, it may be a liquid or preferably a gas. Air is preferred for filling the cavity, on account of its ready availability and easy handling.

By fluid impingement the fastening element fixes the object to be fastened in the vehicle, preferably with a positive fit. The positive-fit connection has the advantage that even with a change of the surrounding pressure or with temperature fluctuations, which may have an influence on the volume within the fastening element, it is always ensured that the connection is not compromised by this.

The fastening element may, however, advantageously also be designed such that, by the fluid impingement, it fixes the object to be fastened in the vehicle with a non-positive fit. The fixation in the vehicle with a non-positive fit has the advantage that a play-free fastening is always effected. Noise emissions between the fastening parts may be avoided reliably or at least reduced by the fastening with a non-positive fit. The fastening with a non-positive fit furthermore has the advantage that it has damping properties for the complete system, thus leading to a reduction of oscillation, and thus a low material loading. Advantageously, the fastening system is designed such that a non-positive fit and a positive fit of the fastening element are given after fluid pressure impingement. The fluid pressure impingement of the fastening element would thereby first result in a positive fit, which fastens the object in the vehicle, and a non-positive fit additionally sets in with a further fluid pressure impingement.

Preferably, the object and/or the vehicle comprises means for receiving the fastening element, preferably with a positive-fit. The fastening element may either lie loosely on these means or even be fastened on them, wherein the means ensure that the fastening element is located in the position necessary for fixing the object, when fastening the object on the vehicle. The means for receiving the fastening element may be formed on the object and/or the vehicle, for example in the form of projections, grooves, hooks, or the like. The means for receiving the fastening element may also include, for example, profile strips, whose profiles are adapted to the fluid-impinged shape of the fastening element, and which consist of a plastic or lightweight metal, preferably aluminum.

In an advantageous embodiment, the fastening element is designed as a part of the object to be fastened. This design simplifies the fastening of the object on the vehicle, since the fastening element does not need to be separately positioned at the fastening location between the object and the vehicle.

Usefully, with the fastening system according to the invention, at least one pump is provided for fluid impingement of the fastening element. With this pump the fluid is delivered into the cavity of the fastening element, and the cavity is filled with pressure, such that it changes its shape. Preferably, the pump is part of a supply system with which one or preferably several fastening elements are supplied with the fluid. The pump may, however, also advantageously form a part of the fastening element itself.

The fastening element advantageously comprises a conduit connection with a preferably mechanically unlockable return valve. The fluid impingement of the cavity in the fastening element for fastening the object on the vehicle is effected via this conduit connection. The mechanically unlockable return valve is preferably designed such that, on the one hand, it prevents an unintended flow of the fluid out of the fastening element, and on the other hand, may be manually unlocked, e.g., for disassembly, in order thereby to discharge the fluid from the cavity of the fastening element in a simple manner. This permits a simple release of the fastening of the object on the vehicle, for example when this needs to be disassembled for maintenance and overhaul purposes.

The fastening element is advantageously designed such that it changes its shape automatically, so that no pump is required for fluid impingement of the fastening element. For this purpose, the cavity of the fastening element, in its condition of assembly, is subjected to a vacuum, closed by a suitable valve. In its condition of assembly the thus-evacuated fastening element usefully has such a volume or such a cross-sectional contour, that it may be brought into its position of assembly in a suitable manner. By actuating the valve of the fastening element, surrounding air may flow into its cavity, which leads to an expansion of the fastening element. In this manner, one may automatically create a positive fit and/or non-positive fit connection with the fastening element, between the object to be fastened and the vehicle. For the disassembly of the fastening element, it is envisaged to suction air located in the cavity of the fastening element by a vacuum pump.

The fastening element is advantageously essentially designed in a flexible tube-shaped form. By this design, the contact regions between the fastening element and the object and the vehicle may be designed particularly large, so that large holding forces may be produced with a low surface pressure. It is also conceivable to design a flexible tube-shaped fastening element so long, that several objects may be fixed on the vehicle with it, which further reduces the assembly effort.

If smaller or lighter objects are to be fastened in a vehicle, it may also be beneficial if the fastening element is designed in a spherical or egg-shaped form.

In order for the fastening element to be able to change its shape, in particular its volume and its cross-sectional contour, it is advantageously formed of an elastomeric material. For example, the fastening element may be formed of polyurethane or silicone, wherein polyurethane may also be applied with low temperatures down to −30° C. due to its temperature resistance.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic cross-sectional view of a fastening system according to embodiments of the invention; and

FIG. 2 is a cross-sectional view of a further embodiment of the fastening system according to FIG. 1.

### DETAILED DESCRIPTION OF THE INVENTION

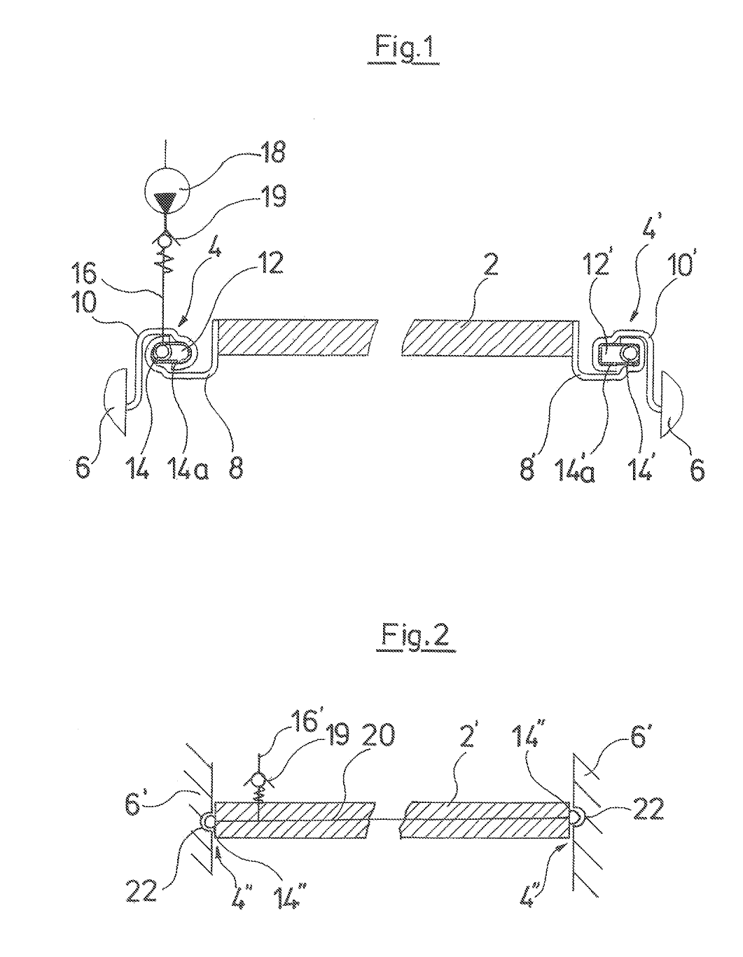

A console 2 of a personal service unit, of the type arranged above the seats of passengers in a passenger aircraft, is represented in FIG. 1. At its horizontally spaced sides, the console 2 is connected to a receiver frame 6 by the fastening system 4 (left) and 4′ (right). FIG. 1 shows two different fastening systems 4 and 4′ for illustrating different embodiments of the fastening system, wherein typically either the fastening system 4 or the fastening system 4′ is used on each side.

The fastening system 4 and 4′ comprises holding elements 8 and 8′ respectively, which are arranged on that side of the console 2 which faces the receiver frame 6. The holding elements 8 and 8′ are profiled to be roughly U-shaped in cross section, so that first they extend downwardly with a limb on the side of the console 2, in order then to extend by 90° into the web region lying roughly horizontally in the installation position, which then in turn is bent upwardly by 90° into the outer limb, wherein the outer limb is designed essentially in a C-shape, so that the hook-like profiles in the cross section of FIG. 1 result.

Holding elements 10 and 10′ are also arranged on the receiver frame 6. These holding elements 10 and 10′ are likewise designed as profiles, which are fastened on the receiver frame 6 and extend on these in the longitudinal direction. The holding elements are likewise essentially U-shaped in cross section, but extend first from the receiver frame 6 at a certain distance to the top, are then bent by 90° toward the web region, in order after a further 90° bending, to merge into the C-shaped outer limb region. As seen from FIG. 1, the holding elements 8 and 10 or 8′ and 10′ are designed corresponding to one another, and arranged with one another, such that together they almost completely enclose an inner space 12 or 12′, wherein the inner space 12 formed by the holding elements 8 and 10 has an elliptical cross section, and the inner space 12′ formed by the holding elements 8′ and 10′ has a rectangular cross section.

Flexible tube-shaped fastening elements 14 and 14′ of elastomeric material are arranged in the inner spaces 12, 12′ formed by the holding elements 8 and 10, and 8′ and 10′, respectively. A fluid connection for connecting to a fluid conduit 16 is provided on the fastening element 14, and a pump 18 with which a fluid, preferably air, may be delivered into the hollow inner space of the fastening element 14, is connected to the fluid conduit.

Impinged with the fluid, the fastening element 14 or 14′ expands and changes its shape. Fastening elements 14a and 14a′ are shown in FIG. 1, which represent the fastening elements 14 and 14′ after impingement by fluid. The expanded fastening elements 14 and 14′, which without fluid impingement have a circular cross section, expand to the fastening element 14a with an oval cross-sectional contour, and to the fastening element 14′a with a rectangular cross section. In the expanded condition, the fastening elements 14a and 14′a completely fill the inner space 12 and 12′ formed by holding elements 8 and 10, and 8′ and 10′, respectively.

For this purpose, the contact regions of the holding elements 8 and 8′ with the expanded fastening element 14a, as well as the contact regions of the holding elements 10 and 10′ with the expanded fastening elements 14a′, have a shape which corresponds to the outer contour of the respective expanded fastening elements 14a and 14′a. In this manner, a positive fit is created between the fastening element 14a, the holding element 8 and the holding element 10, as well as between the fastening element 14′a, the holding element 8′ and the holding element 10′, in their horizontal contact regions, as well as a non-positive fit in the vertically running contact regions, whereby the holding elements 8, 8′ are clamped with the holding elements 10, 10′. Accordingly, the console 2 is securely fastened on the receiver frame 6.

A return valve 19 arranged in a supply conduit 16 prevents an unintended flow of the fluid out of the fastening element 14a, so that the console 2 may not detach unintentionally from the receiver frame 6. The return valve 19 is designed such that it may be manually unlocked, so that the console 2 may be disassembled from the receiver frame 6 for conversion and/or maintenance purposes.

FIG. 2 shows a further embodiment of the fastening system 4″. Here, in each case, a flexible tube-shaped fastening element 14″ is arranged on a console 2′ on its side surfaces facing a receiver frame 6′. A supply conduit 20, which connects the two fastening elements 14″ and to which a fluid conduit 16′ is connected, is arranged in the console 2′. A return valve 19 via which the fluid may be introduced into or let out of the fastening elements 14″ in the above-described manner, is also arranged on this fluid conduit 16″.

The receiver frame 6′ comprises two groove-like recesses 22. This recess 22 serves for receiving the two fastening elements 14″. If the fastening elements 14″ are impinged with the fluid, then after the expansion, they are fixed by the fluid in the recess 22 by a positive and non-positive fit, and the console 2′ is fastened on the receiver frame 6′.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An assembly comprising:
a vehicle;
an object to be fastened; and
at least one fastening element arranged between the object to be fastened and the vehicle, the fastening element being part of the object to be fastened,
wherein the fastening element comprises at least one cavity which may be changed in shape by fluid impingement, such that the fastening element fixes the object in the vehicle by the shape change and with a positive fit by the fluid impingement.

2. The assembly according to claim 1, wherein the fastening element fixes the object to be fastened in the vehicle with both the positive and a non-positive fit by the fluid impingement.

3. The assembly according to claim 1, wherein at least one of the object and the vehicle comprises means for positive fit receiving of the fastening element.

4. The assembly according to claim 1, wherein at least one pump is provided for the fluid impingement of the fastening element.

5. The assembly according to claim 4, wherein the pump is part of the fastening element.

6. The fastening system according to claim 1, wherein the fastening system changeable in shape in an automatic manner.

7. The assembly according to claim 1, wherein the fastening element comprises a conduit connection having a mechanically unlockable return valve.

8. The assembly according to claim 1, wherein the fastening element comprises a flexible tubing.

9. The assembly according to claim 1, wherein the fastening element has a spherical form.

10. The assembly according to claim 1, wherein the fastening element comprises an elastomeric material.

11. The assembly according to claim 1, wherein the vehicle is an aircraft.

12. The assembly according to claim 1, wherein the vehicle is an aircraft having a receiver frame arranged in a cabin of the aircraft, the object is an aircraft console to be fastened to the aircraft receiver frame, and the at least one fastening element is arranged between the aircraft console and the aircraft receiver frame.

13. The assembly according to claim 12, wherein the at least one fastening element fixes the aircraft console to the aircraft receiver frame with both the positive and a non-positive fit by the fluid impingement.

14. An assembly comprising:
a vehicle;
an object to be fastened; and
two fastening elements at opposing sides of the object, each fastening element being arranged between the object to be fastened and the vehicle, each fastening element being part of the object to be fastened, the object comprising a supply conduit that connects the two fastening members,
wherein a fluid conduit is connected to the supply conduit and wherein the fastening element comprises at least one cavity which may be changed in shape by fluid impingement, such that the fastening element fixes the object in the vehicle by the shape change and with a positive fit by the fluid impingement.
